(19) United States
(12) Patent Application Publication
(10) Pub. No.: US 2026/0194683 A1
(43) Pub. Date: Jul. 9, 2026

(54) System and Method for Automatic Petrophysical Logs Alignment

(71) Applicant: Saudi Arabian Oil Company, Dhahran (SA)

(72) Inventors: Muhammad Al Readean, Dhahran (SA); Faisal Alotaibi, Khobar (SA)

(73) Assignee: Saudi Arabian Oil Company, Dhahran (SA)

(21) Appl. No.: 19/010,902

(22) Filed: Jan. 6, 2025

(51) Int. Cl. G01V 5/04; G01V 5/14

(52) U.S. Cl. CPC G01V 5/045; G01V 5/14

(57) ABSTRACT

A method of characterizing a reservoir by automatic depth alignment of petrophysical logs, including: receiving a first and second correlation logs in a depth-domain; transforming, using a Fast Fourier Transform (FFT), the first correlation log in the depth-domain into a first frequency-domain log; transforming, using the FFT, the second correlation log in the depth-domain into a second frequency-domain log; determining, using the first and second frequency-domain logs, a correlation curve of the first and second correlation logs; determining, using the correlation curve, a correlation metric of the first and second correlation logs; determining, using the correlation curve, an alignment shift for the first and second correlation logs and a depth-corrected second correlation log by applying the alignment depth shift to the second correlation log; updating and evaluating the correlation metric after applying the alignment shift; and outputting the depth-corrected second correlation log to a subsequent process of reservoir characterization.

### TECHNICAL FIELD

Embodiments of the disclosure generally relate to the characterization of hydrocarbon reservoirs, and more particularly, to methods and systems for aligning correlation logs to establish spatial correlation between logging jobs to a specific reference depth.

### BACKGROUND

A rock formation that resides under the Earth's surface is often called a “subsurface” formation. A subsurface formation that contains a subsurface pool of hydrocarbons, such as oil and gas, is usually referred to as a “hydrocarbon reservoir.” Hydrocarbons are typically extracted (or “produced”) from a hydrocarbon reservoir by way of a hydrocarbon well. A hydrocarbon well normally includes a wellbore (or “borehole”) that is drilled into the reservoir by traversing a subterranean formation. For example, a hydrocarbon well may include a wellbore that extends into the rock of a reservoir to facilitate the extraction (or “production”) of hydrocarbons from the reservoir, the injection of fluids into the reservoir, or the evaluation and monitoring of the reservoir. In particular, the wellbore may include one or more lateral wellbores extending from a parent (or main) wellbore. The one or more lateral wellbores may provide additional wells as an open hole sidetrack or a cased junction with pressure isolation and reentry capability. For example, a lateral wellbore may be drilled by diverting a milling tool in the parent wellbore through an opening which is a window of a casing string. Well logging is a technique used to make a detailed record in a well log which measures petrophysical properties of the subterranean formations through a drilled borehole using different logging tools included in a bottom hole assembly (BHA) located at the lowest part of a drill string. The well log may be used to characterize the subsurface physical properties of fluids and rocks and may include logs such as gamma ray, spontaneous potential (SP), electrical, acoustic, caliper, formation density, photoelectric absorption, neutron porosity, stimulated radioactive responses, electromagnetic, nuclear magnetic resonance, pressure, etc.

### SUMMARY

The following presents a simplified summary of the disclosed subject matter in order to provide a basic understanding of some aspects of the subject matter disclosed herein. This summary is not an exhaustive overview of the technology disclosed herein. It is not intended to identify key or critical elements of the disclosed subject matter or to delineate the scope of the disclosed subject matter. Its sole purpose is to present some concepts in a simplified form as a prelude to the more detailed description that is discussed later.

In one or more embodiments, the present disclosure provides a method for characterizing a reservoir by automatic depth alignment of petrophysical logs. The method may receive a first correlation log and a second correlation log in a depth-domain. The method may further transform, using a Fast Fourier Transform (FFT), the first correlation log in the depth-domain into a first frequency-domain log. The method may further transform, using the FFT, the second correlation log in the depth-domain into a second frequency-domain log. The method may further determine, using the first frequency-domain log and the second frequency-domain log, a correlation curve of the first correlation log and the second correlation log. The method may further determine, using the correlation curve, a correlation metric of the first correlation log and the second correlation log. The method may further compare the correlation metric to a first predetermined threshold. In response to determining the correlation metric is below the first predetermined threshold, the method may further determine, using the correlation curve, an alignment shift between the first correlation log and the second correlation log and a depth-corrected second correlation log by applying the alignment depth shift to the second correlation log. The method may further update the correlation metric using the first correlation log and the depth-corrected second correlation log. The method may further compare the correlation metric to a second predetermined threshold. In response to determining the correlation metric is above the second predetermined threshold, the method may output the depth-corrected second correlation log to a subsequent process of reservoir characterization.

In one or more embodiments, the present disclosure provides a system for characterizing a reservoir by automatic depth alignment of petrophysical logs. The system may include a processor and a computer-readable non-transitory storage medium comprising instructions that, when executed by the processor, cause the processor to perform operations. The operations include receiving a first correlation log and a second correlation log in a depth-domain. The operations further include transforming, using a Fast Fourier Transform (FFT), the first correlation log in the depth-domain into a first frequency-domain log. The operations further include transforming, using the FFT, the second correlation log in the depth-domain into a second frequency-domain log. The operations further include determining, using the first frequency-domain log and the second frequency-domain log, a correlation curve of the first correlation log and the second correlation log. The operations further include determining, using the correlation curve, a correlation metric of the first correlation log and the second correlation log. The operations further include comparing the correlation metric to a first predetermined threshold. In response to determining the correlation metric is below the first predetermined threshold, the operations further include determining, using the correlation curve, an alignment shift between the first correlation log and the second correlation log and a depth-corrected second correlation log by applying the alignment depth shift to the second correlation log. The operations further include updating the correlation metric using the first correlation log and the depth-corrected second correlation log. The operations further include comparing the correlation metric to a second predetermined threshold. In response to determining the correlation metric is above the second predetermined threshold, the operations further include outputting the depth-corrected second correlation log to a subsequent process of reservoir characterization.

In one or more embodiments, the present disclosure provides a non-transitory computer-readable medium comprising instructions, when executed by a processor, cause the processor to perform operations. The operations include receiving a first correlation log and a second correlation log in a depth-domain. The operations further include transforming, using a Fast Fourier Transform (FFT), the first correlation log in the depth-domain into a first frequency-domain log. The operations further include transforming, using the FFT, the second correlation log in the depth-domain into a second frequency-domain log. The operations further include determining, using the first frequency-domain log and the second frequency-domain log, a correlation curve of the first correlation log and the second correlation log. The operations further include determining, using the correlation curve, a correlation metric of the first correlation log and the second correlation log. The operations further include comparing the correlation metric to a first predetermined threshold. In response to determining the correlation metric is below the first predetermined threshold, the operations further include determining, using the correlation curve, an alignment shift between the first correlation log and the second correlation log and a depth-corrected second correlation log by applying the alignment depth shift to the second correlation log. The operations further include updating the correlation metric using the first correlation log and the depth-corrected second correlation log. The operations further include comparing the correlation metric to a second predetermined threshold. In response to determining the correlation metric is above the second predetermined threshold, the operations further include outputting the depth-corrected second correlation log to a subsequent process of reservoir characterization.

Other aspects and advantages of the claimed subject matter will be apparent from the following description and the appended claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a schematic diagram of a reservoir environment in accordance with one or more embodiments.

FIG. 2 illustrates a diagram of a distributed computer system using a log alignment controller in accordance with one or more embodiments.

FIG. 3 illustrates gamma ray logs for different logging jobs before shifting in accordance with one or more embodiments.

FIG. 4 illustrates gamma ray logs for different logging jobs after shifting in accordance with one or more embodiments.

FIG. 5A illustrates a flowchart that shows a method for applying a general workflow of depth alignment in accordance with one or more embodiments.

FIG. 5B illustrates a flowchart that shows a method for data preprocessing and standardization in accordance with one or more embodiments.

FIG. 5C illustrates a flowchart that shows a method for applying an alignment procedure to two petrophysical logs in accordance with one or more embodiments.

FIG. 6 illustrates a functional block diagram of a computer system in accordance with one or more embodiments.

While certain embodiments will be described in connection with the illustrative embodiments shown herein, the subject matter of the present disclosure is not limited to those embodiments. On the contrary, all alternatives, modifications, and equivalents are included within the spirit and scope of the disclosed subject matter as defined by the claims. In the drawings, which are not to scale, the same reference numerals are used throughout the description and in the drawing figures for components and elements having the same structure.

### DETAILED DESCRIPTION

In the following description, for purposes of explanation, numerous specific details are set forth in order to provide a thorough understanding of the inventive concept. In the interest of clarity, not all features of an actual implementation are described. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” or “another embodiment” means that a particular feature, structure, or characteristic described in connection with the embodiment is included in at least one embodiment of the disclosed subject matter, and multiple references to “one embodiment” or “an embodiment” or “another embodiment” should not be understood as necessarily all referring to the same embodiment.

This disclosure pertains to systems, methods, and computer-readable media for characterizing a reservoir by automatic depth alignment of petrophysical logs. Techniques disclosed herein apply an automatic log alignment workflow to tie a plurality of petrophysical logs to the same reference depth. In particular, the automatic log alignment workflow may be implemented for depth matching and shifting by using Fast Fourier Transform (FFT) to convert petrophysical logs data from a depth-domain to a frequency-domain. Thus, the automatic log alignment workflow may be used to extract, prepare, generate, and shift well log data using an improved correlation of the petrophysical logs based on the similarity of the log signatures as guidance without human intervention. Traditional log alignment techniques may apply depth matching and shifting based on one or more formation tops as a way to guide the alignment using expert systems, neural networks, dynamic programming, or a combination of them. However, these traditional log alignment techniques may require human intervention and input to guide the depth alignment of the petrophysical logs. For example, such traditional log alignment techniques may be implemented in a trial-and-error manner to achieve optimal matching between different petrophysical logs. The automatic log alignment process described in the disclosure may efficiently align two petrophysical logs together using FFTs in subsequent jobs to assess the match between the two petrophysical logs before and after the induced shifting. For example, the automatic log alignment workflow may be used to align a petrophysical log from a wireline job with a petrophysical log from a Logging-While-Drilling (LWD) job in the same well. As another example, the automatic log alignment workflow may be used to align a petrophysical log from an LWD job in a lateral wellbore with a petrophysical log from an LWD job in a parent wellbore. The automatic log alignment workflow may thus be integrated into an interactive process of reservoir characterization for well log analysis and interpretation.

Additionally, in some embodiments, the automatic log alignment workflow may be integrated into edge or centralized computing within a distributed computing system of cloud computing and edge computing. For example, an operator may use a web application from an Internet of Things (IoT) client device, such as a mobile phone, a tablet, or a laptop, within the distributed environment to receive input petrophysical logs data to apply the automatic log alignment workflow to the input petrophysical logs data. The web applications and the petrophysical logs data may be stored on a distributed environment server. Therefore, the distributed network system may deliver computing power and storage capacity as a service to a community of user devices via networks. As a result, the distributed network system may be dramatically scaled up and down in complex communications environments to meet the needs of users.

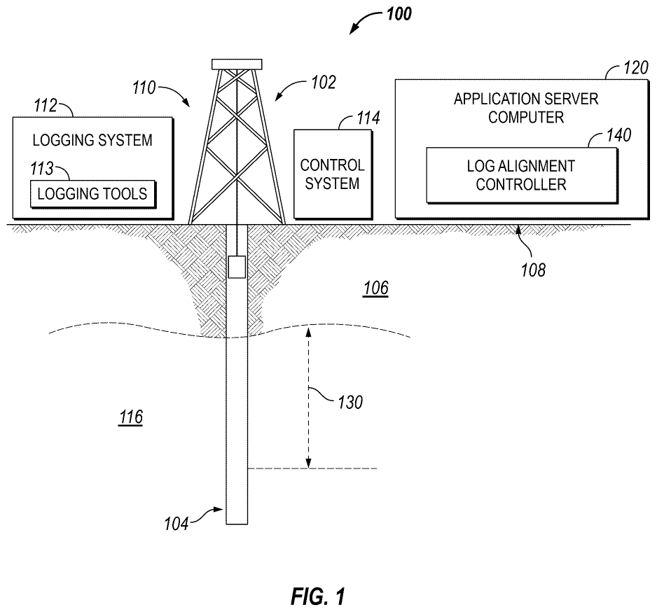

FIG. 1 is a diagram that illustrates a hydrocarbon reservoir environment (for example, reservoir environment or well environment) 100 in accordance with one or more embodiments. In the illustrated embodiment, reservoir environment 100 includes a hydrocarbon reservoir (“reservoir”) 116 located in a subsurface formation (“formation”) 106, and a hydrocarbon reservoir development system 110. Formation 106 may include a porous or fractured rock formation that resides underground, beneath the Earth's surface (“surface”) 108. Reservoir 116 may include a portion of formation 106 that contains (or that is determined to contain) a subsurface pool of hydrocarbons, such as oil and gas. Formation 106 and reservoir 116 may each include different layers of rock having varying characteristics (for example, varying degrees of permeability, porosity, lithology, geology, or fluid saturation). Hydrocarbon reservoir development system 110, such as a drilling system, may facilitate extraction (or “production”) of hydrocarbons from reservoir 116. Hydrocarbon reservoir development system 110 may include a drill string, a drill bit, a mud circulation system, and the like for use in extending wellbore 104 into formation 106.

In some embodiments, hydrocarbon reservoir development system 110 includes a hydrocarbon reservoir control system (“control system”) 114 and (one or more) wells 102. Control system 114 may include hardware, software, or both for managing drilling operations, maintenance operations, or both. For example, control system 114 may include one or more programmable logic controllers (PLCs) that include hardware, software, or both with functionality to control one or more processes performed by hydrocarbon reservoir development system 110. Specifically, a PLC may control valve states, fluid levels, pipe pressures, warning alarms, drilling parameters (for example, torque, weight on bit (WOB), standpipe pressure (SPP), revolutions per minute (RPM), etc.) pressure releases, or any combination thereof throughout a drilling rig. In particular, a PLC may be a ruggedized computer system with the functionality to withstand vibrations, extreme temperatures, wet conditions, dusty conditions, or any combination thereof for example, around a drilling rig. In some embodiments, control system 114 includes a computer system that is the same as or similar to that of computer system 1300 described with regard to at least FIG. 13. Without loss of generality, the term “control system” may refer to a drilling operation control system that is used to operate and control the equipment, a drilling data acquisition and monitoring system that is used to acquire drilling process and equipment data and to monitor the operation of the drilling process, or a drilling interpretation software system that is used to analyze and understand drilling events and progress.

In some embodiments, control system 114 controls operations for developing reservoir 116. Although FIG. 1 illustrates control system 114 as being disposed at a location proximal to well 102, this may not be the case. For example, control system 114 may be provided at a remote location (for example, remote control center, data center, server farm, and the like) that is remote from well 102. In some embodiments, control system 114 determines drilling parameters for well 102 in reservoir 116, determines operating parameters for well 102 in reservoir 116, controls drilling of well 102 in accordance with drilling parameters, or controls operating well 102 in accordance with the operating parameters. This can include, for example, control system 114 determining drilling parameters (for example, determining well location and trajectory) for reservoir 116, controlling drilling of well 102 in accordance with the drilling parameters (for example, controlling a well drilling system of the hydrocarbon reservoir development system 110 to drill well 102 at the well location and with wellbore 104 following the trajectory), determining operating parameters (for example, determining production rates and pressures for “production” well 102 and injection rates and pressure for “injection” well 102), and controlling operations of well 102 in accordance with the operating parameters (for example, controlling a well operating system of the hydrocarbon reservoir development system 110 to operate the production well 102 to produce hydrocarbons from reservoir 116 in accordance with the production rates and pressures determined for well 102, and controlling the injection well 102 to inject substances, such as water, into reservoir 116 in accordance with the injection rates and pressures determined for well 102).

In some embodiments, well 102 may include wellbore 104 that extends from surface 108 into a target zone of formation 106, such as reservoir 116. Wellbore 104 may be created, for example, by a drill bit boring along a path (or trajectory) through formation 106 and reservoir 116. In some embodiments, formation 106 may include various formation characteristics of interest, such as formation porosity, formation permeability, water saturation, irreducible water saturation, rock type, temperature, density, and the like. Porosity may indicate how much space exists in a particular rock within an area of interest in formation 106, where oil, gas, water, or any combination thereof may be trapped. Permeability may indicate the ability of liquids and gases to flow through the rock within the area of interest. Water saturation may indicate the fraction of water in a given pore space. Irreducible water saturation may indicate the ratio of irreducible total fluid volume to effective porosity for a formation within the area of interest. Rock type may indicate the type of rock for a formation with the area of interest. For example, a tight chalk may have a greater strength property that requires a greater pump pressure for breaking the chalk. Temperature may indicate the temperature or the temperature gradient for a formation with the area of interest. Density may indicate the bulk density for a formation with the area of interest.

In some embodiments, reservoir environment 100 may include a logging system 112. Logging system 112 may include one or more logging tools 113, such as a neutron magnetic resonance (NMR) spectrometer, for use in generating well logs and core sample data of formation 106. Logging tools 113 may enable the characterization of petrophysical properties data, such as density, porosity, permeability, rock type, water saturation, irreducible water saturation, etc. Logging tool 113 may be inserted into wellbore 104 or used in the laboratory to acquire measurements, such as well logs and core sample data as the tool traverses a depth interval 130, such as a targeted reservoir section of wellbore 104. The plot of the logging measurements versus depth may be referred to as a “log” or “well log.” Well logs may provide depth measurements of well 102 that describe such reservoir characteristics as formation porosity, formation permeability, resistivity, density, water saturation, total organic content (TOC), volume of kerogen, Young's modulus, Poisson's ratio, and the like. The resulting logging measurements may be stored, processed, or both, for example, by control system 114, to generate corresponding well logs for well 102. A well log may include, for example, a plot of a logging response time versus true vertical depth (TVD) across the depth interval 130 of wellbore 104.

In some embodiments, control system 114 may be communicatively coupled to application server computer 120 to drive the operation of application server computer 120 under stored program control. For example, control system 114 may include a control computer that may incorporate wireless networking communication interfaces to deliver a graphical user interface or other user interface to a compatible browser, application, or app of a mobile computing device, and to receive input signals and commands relating to application server computer 120 from control system 114. For example, control system 114 may be configured to determine rock properties from well logs and core samples. As another example, control system 114 may be configured to determine reservoir characteristics may be determined using a variety of different techniques. For example, certain reservoir characteristics of a geological model may be determined via coring, such as physical extraction of rock samples, to produce core samples, logging operations, or both, such as wireline logging, logging-while-drilling (LWD), and measurement-while-drilling (MWD). Coring operations may include physically extracting a rock sample from a region of interest within wellbore 104 for detailed laboratory analysis. For example, when drilling an oil or gas well, a coring bit may cut plugs (or “cores” or “core samples”) from formation 106 and bring the plugs to the surface, and these core samples may be analyzed at the surface, such as in a lab, to determine various characteristics of the formation 106 at the location where the sample was obtained.

Misaligned well logs are developed from multiple logging jobs at different times to collect data about wellbores and subsurface formations. Depth misalignment between different log curve measurements may suppress possible correlations between formation properties, leading to imprecise interpretation or even misinterpretation. For example, misalignment in log depth may result in mismatching the log readings which impacts the quality of the petrophysical interpretation which is done at a later stage to describe the subsurface formations. Thus, depth matching may be used in petrophysical interpretation to correlate or compare curve shapes of two or more well logging curves which have been generated either during the same or different traversals of the logging instrument through the same borehole. Prior art log alignment techniques may be tedious and require careful bulk shifting of the well logs going through different trials to achieve the most possible match visually. These traditional log alignment techniques rely on human expertise to match similar log signatures, such as peaks, troughs, and bed boundaries, between two petrophysical log curves in a manual process which is often subjective, error-prone, and cumbersome. However, this manual process is usually labor-intensive and time-consuming. Furthermore, the manual process needs to be repeated for every new logging job acquired during the lifetime of the well. Consequently, there is no quality control to assess the quality of the alignment result.

In accordance with embodiments of the disclosure, application server computer 120 may include a log alignment controller 140. Log alignment controller 140 may be configured to apply an automatic log alignment workflow to determine an alignment metric of log alignment for two input petrophysical logs, such as gamma ray, neutron porosity, etc. Depth alignment of petrophysical logs is a process of ensuring that all logs from subsequent logging jobs, acquired at different times, are aligned across the same reference depth. Log alignment controller 140 may be implemented to tie measurements from a first petrophysical log to a second petrophysical log which is a reference log during drilling and logging before any petrophysical analysis. Thus, log alignment controller 140 may provide an efficient mechanism for the automatic alignment of well logs to ensure the well logs are aligned across the same reference depth.

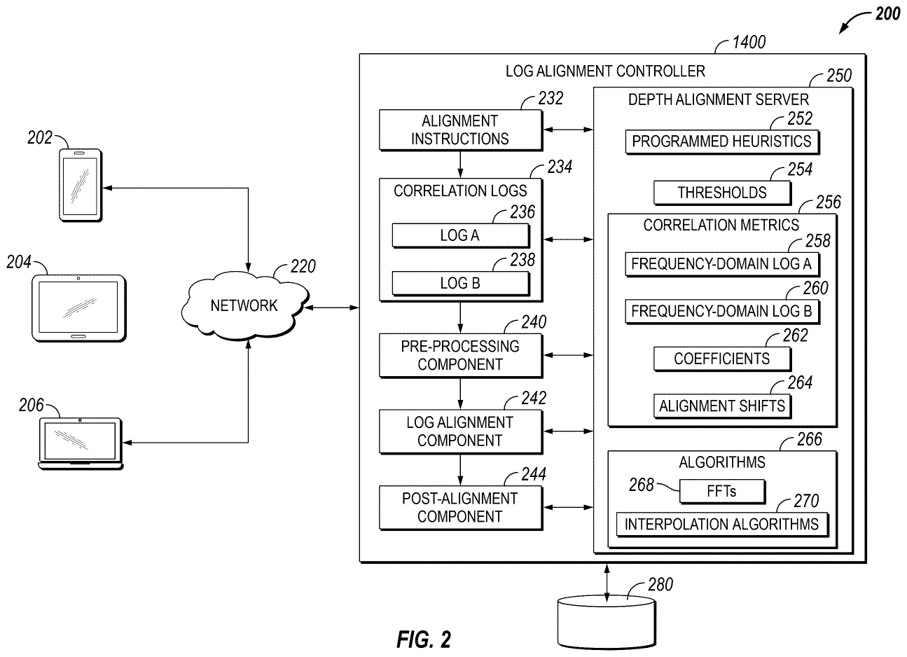

FIG. 2 illustrates a computer system 200 using a log alignment controller in accordance with one or more embodiments. In particular, FIG. 2 shows a computer system 200 showing the context of use and functional elements with which one embodiment could be implemented. In some embodiments, computer system 200 includes components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. FIG. 2 illustrates only one of many possible arrangements of components configured to execute the programming described herein. Other arrangements may include fewer or different components, and the division of work between the components may vary depending on the arrangement.

In some embodiments, computer system 200 includes a plurality of computing devices, such as a mobile phone 202, a tablet 204, and a laptop 206 that are communicatively coupled via network 220 to a log alignment controller 140. Each of the plurality of computing devices may include any kind of computing device such as a laptop computer, tablet computer, or smartphone. While the nature of the applications herein can benefit from the use of mobile computing devices, in some embodiments, a desktop computer or a workstation could be used. For clarity, FIG. 2 shows three computing devices 202, 204, and 206 but in practical embodiments, the system 200 may include thousands to millions of computing devices depending upon the processing capacity of log alignment controller 140.

In some embodiments, each of the plurality of computing devices 202, 204, and 206 executes application programs including a browser, which can comprise any application program that is compatible with open protocols and languages such as the hypertext transfer protocol (HTTP) and hypertext markup language (HTML); commercially available examples include INTERNET EXPLORER®, GOOGLE CHROME®, SAFARI®, ANDROID®, FIREFOX®, and EDGE®. In an embodiment, the plurality of computing devices 202, 204, and 206 interact with log alignment controller 140 using the browser to transmit requests for network resources and to receive and render the network resources in the browser using a display device. Examples of network resources can be dynamically generated web pages or HTML code; other sections of this description show examples of web pages with graphical user interfaces that can be rendered as the plurality of computing devices 202, 204, and 206 interoperate with log alignment controller 140. In some embodiments, each of the plurality of computing devices 202, 204, and 206 executes a copy of a special-purpose application which is programmed to implement the user-side functions and screen displays that are described in other sections herein. For example, the plurality of computing devices 202, 204, and 206 may interoperate with a compatible application or function elements hosted at log alignment controller 140 using an application-specific protocol transported over HTTP or other transport protocols; this approach may enable simpler access to mobile computing device sensors, hardware elements, and system services, as well as in-app notifications. As another example, the plurality of computing devices 202, 204, and 206 may use only a browser and HTML for communication and presentation.

In some embodiments, log alignment controller 140 may access the plurality of computing devices 202, 204, and 206 through network 220, which broadly represents any wireline or wireless network, using any satellite or terrestrial network links, such as public or private cloud on the Internet, local area networks (LANs), metropolitan area networks (MANs), wide area networks (WANs), a public switched telephone network (PSTN), campus network, internetworks, or combinations thereof. Network 220 may include the public internet and networked server computers that implement Web2 or Web3 technologies. Network 220 may comprise or support intranets, extranets, or virtual private networks (VPNs). Network 220 may also comprise a public switched telephone network (PSTN) using digital switches and call-forwarding gear. Network 220 may also comprise a public switched telephone network (PSTN) using digital switches and call-forwarding gear.

In some embodiments, computer system 200 may include a distributed edge computing system which implements a decentralized information technology (IT) architecture. For example, in the distributed edge computing system, the computing resources, such as servers, computing nodes, storage devices, and network equipment, are deployed at the edge of the network, such as network 220, close to an edge device near an originating source, such as the plurality of computing devices 202, 204, and 206. In cloud computing, the data is typically processed and stored in large-scale, remote data centers or the cloud. Thus, cloud computing has issues associated with bandwidth, latency, and security associated with a plurality of edge devices, such as in an IoT network or a larger stack edge setup. Therefore, computer system 200 may implement distributed edge computing to improve bandwidth efficiency for a large amount of data from edge applications of the plurality of edge devices that are usually close to the edge of the network.

In some embodiments, log alignment controller 140 may be configured to host or execute a set of alignment instructions 232 which are programmed to generate dynamic HTML or application-specific presentation instructions to transmit via network 220 to the plurality of computing devices 202, 204, 206, in response to calls, signals, or requests from other function elements of log alignment controller 140. In some embodiments, alignment instructions 232 may be programmed to receive two or more petrophysical logs, such as correlation logs 234, to characterize a reservoir. Correlation logs 234 may include a gamma ray log, a neutron log, etc. For example, the gamma ray log measures the natural gamma radiation emanating from a formation split into contributions from each of the major radio-isotopic. As another example, the neutron log measures the hydrogen concentration in a formation.

In some embodiments, log alignment controller 140 may be programmed to include a depth alignment server 250 to implement depth alignment for the received two or more petrophysical logs. In some embodiments, depth alignment server 250 may be configured to extract two correlation logs 234 which include a first correlation log, such as log A 236, and a second correlation log, such as log B 238, from a database 280 which includes different log types, such as gamma ray or neutron porosity depending on the logging job. For example, the first correlation log may be a reference log from a first logging job. As another example, the second correlation log may be a correlation log from a second logging job.

In some embodiments, correlation logs 234 are acquired at different times. Thus, alignment instructions 232 may be programmed to determine a reference depth for correlation logs 234 for subsequent well log analysis and interpretation jobs. For example, the first correlation log and the second correlation log may be acquired from the same wellbore for a clastic rock reservoir. As another example, the first correlation log is acquired from a parent wellbore for a carbonate reservoir and the second correlation log is acquired from a later wellbore extending from the parent wellbore. Log alignment controller 140 may be configured to validate the quality of the first correlation log and the second correlation log so that the first correlation log and the second correlation log may be profiled against measured depth to show missing values, ensuring a data frame is ready for analysis.

In some embodiments, alignment instructions 232 may be programmed to implement a pre-processing component 240 which couples to depth alignment server 250 to determine an initial assessment of the first correlation log and the second correlation log for depth alignment. In some embodiments, pre-processing component 240 may be configured to implement depth alignment server 250 to execute one or more programmed heuristics 252 to evaluate the first correlation log and the second correlation log. In particular, depth alignment server 250 may determine one or more statistical values, such as mean, root mean square (RMS), median, range, mode, interquartile range, etc., for the first correlation log and the second correlation log. Thus, pre-processing component 240 may evaluate the first correlation log and the second correlation log to determine if they may be aligned for depth matching and depth shifting and establish a reference to evaluate the procedure performance. Thus, the first correlation log and the second correlation log may be aligned for depth matching and depth shift when they have similar mean values based on a first predetermined threshold, such as thresholds 254. Furthermore, one of the first correlation log and the second correlation log may be badly affected due to improper measurements in a borehole. For example, the first correlation log includes a gamma ray log which is measured when the borehole suffers from caving. Thus, the gamma ray log is underestimated because there is more drilling mud between the formation and the gamma ray detection to attenuate the gamma rays produced by the formation. Pre-processing component 240 may make corrections to the underestimated gamma ray logs by using one or more logs and correction charts. In some embodiments, in response to determining the first correlation log and the second correlation log are valid, alignment instructions 232 may be programmed to implement a log alignment component 242 which is coupled to depth alignment server 250 to apply an automatic log alignment workflow of depth matching and depth shifting for the first correlation log and the second correlation log. The automatic log alignment workflow includes three steps: (1) a data preprocessing and standardization step; (2) a digital signal processing step; and (3) a data postprocessing and visualization step. Thus, depth alignment server 250 may implement the automatic log alignment workflow to process a plurality of correlation logs to automate the shifting of the petrophysical logs for the subsequent logging jobs.

In some embodiments, in the data preprocessing and standardization step, depth alignment server 250 may be programmed to extract a first sampling rate from the first correlation log. Likewise, depth alignment server 250 may be programmed to extract a second sampling rate from the second correlation log. Using the first sampling rate and the second sampling rate, depth alignment server 250 determines a maximum sampling rate for the first correlation log and the second correlation log when the two correlation logs have different sampling rates. Thus, depth alignment server 250 may use one or more algorithms 266, such as an interpolation algorithm 270, to determine a first interpolated correlation log by applying interpolation to the first correlation log from the first sampling rate to the maximum sampling rate when the first sampling rate is less than the maximum sampling rate. Likewise, depth alignment server 250 may use interpolation algorithm 270 to determine a second interpolated correlation log by applying interpolation to the second correlation log from the second sampling rate to the maximum sampling rate when the second sampling rate is less than the maximum sampling rate. Interpolation algorithms 270 may be used to interpolate a one-dimensional (1-D) log curve by performing kriging, gridding, machine learning regression, or by many other methods familiar to one of ordinary skill in the art. Furthermore, depth alignment server 250 may be programmed to apply a padding zero algorithm to make the size of the input sequence, such as the first correlation log and the second correlation log, equal to a predetermined length, such as the longer length of the first correlation log and the second correlation log. For example, a first correlation log may include a gamma ray curve of 80 feet (ft) at a first sampling rate of 20 samples per ft, and a second correlation log may include a gamma ray curve of 100 ft at a second sampling rate of 40 samples per foot. In such an example, depth alignment server 250 may be used to interpolate the first correlation log from the first sampling rate to the second sampling rate and make the first correction log have a length of 100 ft by tailing zeros to the end of the first correction log.

In some embodiments, in the digital processing step, depth alignment server 250 may be programmed to execute a Fast Fourier Transform (FFT) algorithm, such as FFTs 268, to transform the first correlation log and the second correlation log from a depth-domain to a frequency-domain. In particular, depth alignment server 250 may determine a first frequency-domain log, such as frequency-domain log A 258, using FFTs 268 by transforming the first correlation log in the depth-domain, such as log A 236, to the frequency-domain. Likewise, depth alignment server 250 may determine a second frequency-domain log, such as frequency-domain log B 260, using FFTs 268 by transforming the second correlation log in the depth-domain, such as log B 238, to the frequency-domain. Based on frequency-domain log A 258 and frequency-domain log B 260, depth alignment server 250 may determine a correlation curve of the first correlation log and the second correlation log by generating an inverse of a product of multiplying the first frequency-domain log A 258 with a conjugate of the second frequency-domain log B 260. Based on the correlation curve, depth alignment server 250 may determine a correlation metric 256 of the first correlation log and the second correlation log. In particular, the correlation metric 256 includes a coefficient 262 which is the maximum correlation of the correlation curve, and an index of the maximum correlation coefficient which may be converted to an alignment shift 264 of the second correlation log.

In some embodiments, in the data postprocessing and visualization step, depth alignment server 250 may be programmed to use the alignment shift to determine a depth-corrected second correlation log by applying the alignment depth shift to the second correlation log. In particular, alignment shift 264 between the first correlation log and the second correlation log from the previous steps may be used to shift all logs in the second logging job. Alignment shift 264 may represent the number of samples to be shifted up or down which may be translated to depth measure using the standard sampling rate enforced in the first step. Furthermore, depth alignment server 250 may be programmed to display the first correlation log, the second correlation log, and the depth-corrected second correlation log via a user interface. Thus, depth alignment server 250 may output the depth-corrected second correlation log to an interactive process of reservoir characterization to characterize the reservoir.

In some embodiments, alignment instructions 232 may be programmed to implement a post-alignment component 244 which couples to depth alignment server 250 to validate the depth alignment for the first correlation log and the second correlation log. For example, depth alignment server 250 may recalculate the correlation metric 256 after applying the automatic log alignment workflow to the second correlation log to determine a correlation score. The correlation score may be determined from the maximum correlation of a correlation curve based on the first correlation log and the depth-corrected second correlation log. When the correlation score exceeds a second predetermined threshold, such as thresholds 254, depth alignment server 250 may proceed to apply the alignment shift 264 to correct depth misalignment for other logs in the second logging run.

### Application of the Automatic Log Alignment Workflow

In some embodiments, the automatic log alignment workflow is applied to various field cases with different complexity. The automatic log alignment workflow may provide an accurate and efficient approach to tie two input petrophysical logs together and evaluate the match between the two input petrophysical logs before and after the induced shifting. In particular, the automatic log alignment workflow may be implemented in an interactive reservoir characterization framework as an edge computing solution near the oil or gas well where the data is acquired or as a cloud solution in a centralized manner due to its low computing requirements.

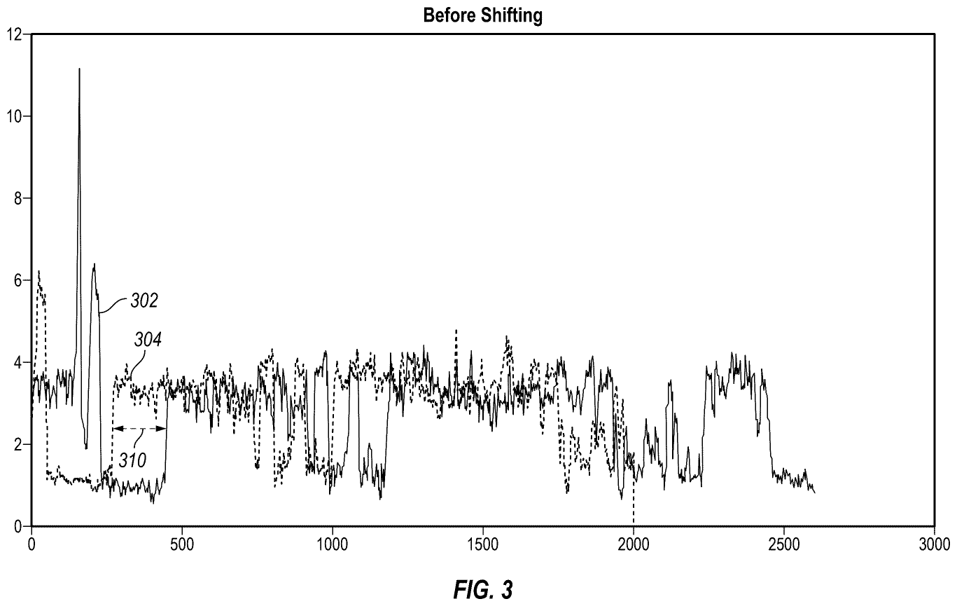

FIG. 3 illustrates gamma ray logs for different logging jobs before shifting in accordance with one or more embodiments. FIG. 3 shows a first gamma ray log 302 and a second gamma ray log 304 without log misalignment correction. In some embodiments, the first gamma ray log 302 may be used as a reference log. In particular, the first gamma ray log 302 has a similar log pattern as the second gamma ray log 304. The automatic log alignment workflow may be implemented to tie the second gamma ray log 304 to the first gamma ray log 302 by using the similarity of the log signatures as guidance. Thus, the automatic log alignment workflow may determine an alignment shift 310 by using a correlation of the first gamma ray log 302 and the second gamma ray log 304.

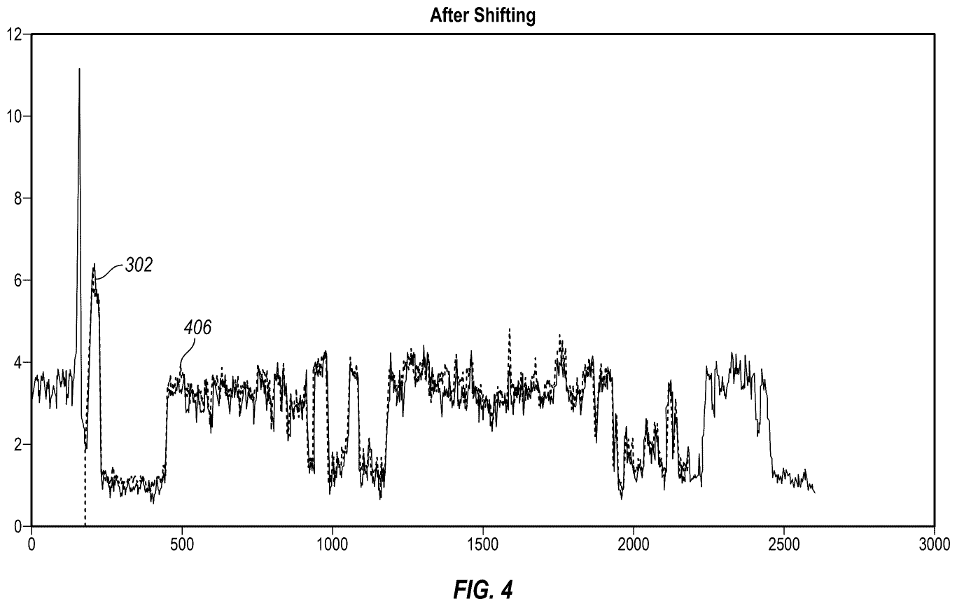

FIG. 4 illustrates gamma ray logs for different logging jobs after shifting in accordance with one or more embodiments. FIG. 4 shows the first gamma ray log 302 and a third gamma ray log 406 which is a depth-corrected gamma ray log based on the second gamma log 304 (referring to FIG. 3) by applying an alignment depth shift to the second gamma ray log 304 (referring to FIG. 3). The third gamma ray log 406 is very consistent with the first gamma ray log 302 in a depth-domain, suggesting high-quality depth matching and shift performance. The automatic log alignment workflow may thus be useful for comparing a gamma ray of a reservoir saturation monitoring logging job against a gamma ray log from a parent LWD job for a shallow section to ensure both jobs are aligned at the same reference depth.

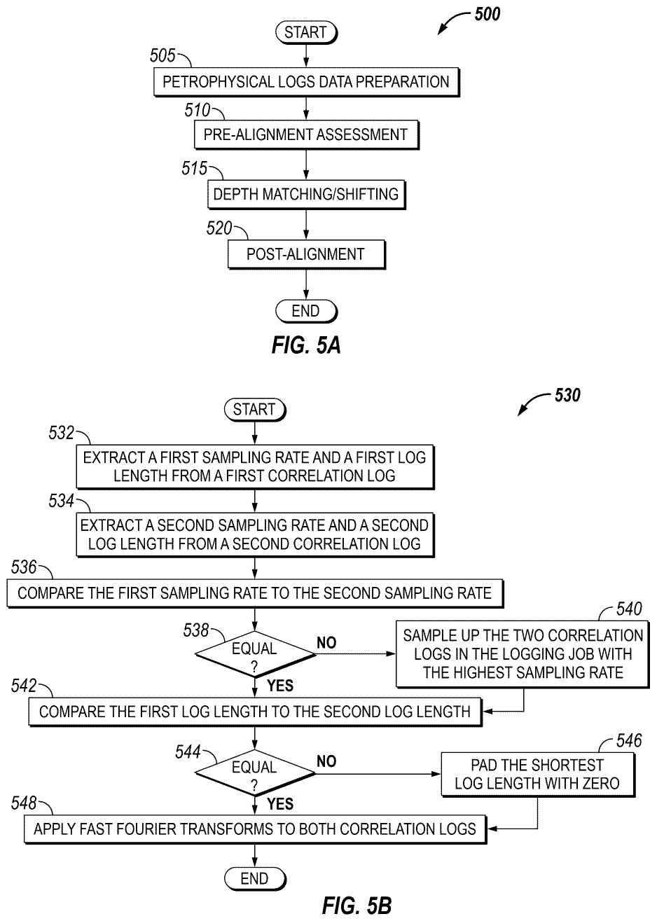

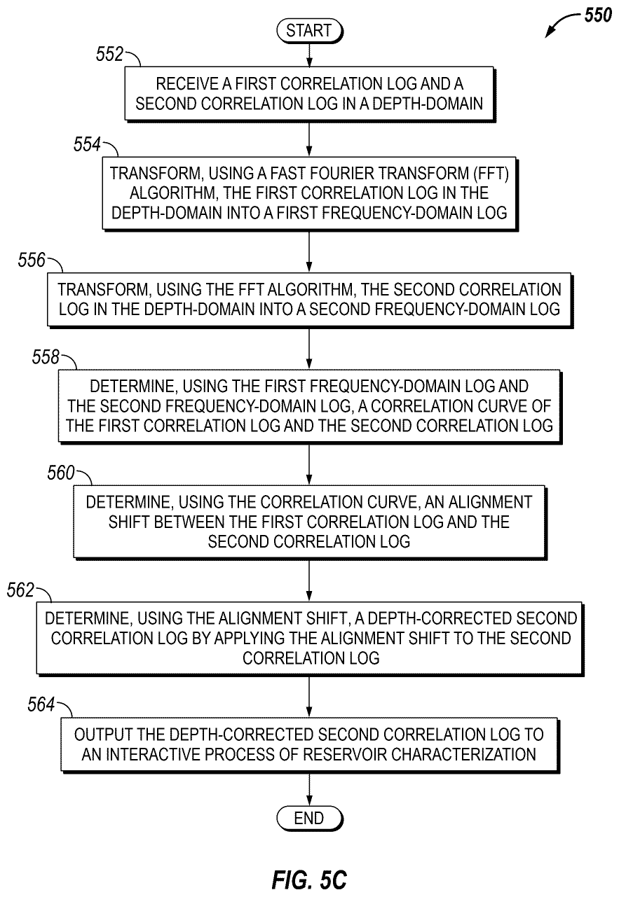

FIGS. 5A, 5B, and 5C depict various methods in accordance with the present techniques. While the various blocks in FIGS. 5A, 5B, and 5C are presented and described sequentially, some or all of the blocks may be executed in different orders, may be combined or omitted, and some or all of the blocks may be executed in parallel. Furthermore, the blocks may be performed actively or passively.

FIG. 5A illustrates a flow chart that shows a method 500 for applying a general workflow of depth alignment in accordance with one or more embodiments. In some embodiments, the automatic log alignment workflow includes several stages to process two input correlation logs to automate the depth matching and shifting of the petrophysical logs in the logging jobs. At block 505, the method 500 includes preparing two input petrophysical logs for depth matching and shifting. In some embodiments, the method 500 may extract the two input petrophysical logs, such as a first correlation log and a second correlation log, from a storage media, such as a database. The two input petrophysical logs may include different log types, such as gamma ray, neutron porosity, etc., depending on the logging job. For example, the first correlation log is associated with an LWD job in a wellbore in which a first parameter, such as gamma ray, is measured while the wellbore is being drilled. The second correlation log is associated with an LWD job in which a second parameter, such as gamma ray, is measured in the same wellbore while drilling the wellbore. As another example, the first correlation log is associated with a wireline job in a parent wellbore and the second correlation log is associated with a lateral well extending from the parent wellbore. In particular, the method 500 may evaluate the data quality of the two input petrophysical logs to ensure that the petrophysical logs data are correctly profiled against measured depth to a proper data frame for analysis.

At block 510, the method 500 includes applying pre-alignment assessment to the two input petrophysical logs. The method 500 may determine a correlation metric between the sequential values of the first correlation log and the second correlation log. The method 500 may use the correlation metric as an indicator of alignment quality. For example, the correlation metric includes a correlation coefficient between the first correlation log and the second correlation log. The method 500 may compare the correlation metric to a first predetermined threshold, such as a value of 0.8, to determine if a depth matching and shifting procedure is needed to tie the two input petrophysical logs. For example, the method 500 determines a correlation coefficient of 0.3 between the first correlation log and the second correlation log which is below the first predetermined threshold of 0.8. Thus, the method 500 may proceed to block 515 to apply the alignment procedure. As another example, the method 500 determines a correlation coefficient of 0.9 between the first correlation log and the second correlation log which is above the first predetermined threshold of 0.8. Thus, the method 500 may proceed to block 520 to apply the post-alignment procedure. Additionally, the method 500 may determine a reference depth for the depth matching and shift procedure of the two input petrophysical logs. As an example, the method 500 selects the reference depth from one of the two input petrophysical logs for the depth matching and shift procedure.

At block 515, the method 500 includes applying a depth matching and shifting procedure to the two input petrophysical logs. In particular, the method 500 may implement the automatic log alignment workflow to tie the two input petrophysical logs based on the reference depth. For example, the method 500 may apply an FFT algorithm to transform the input petrophysical logs by converting them from a spatial domain to a frequency domain to identify an alignment shift, such as a maximum lag, between the two input petrophysical logs. The alignment shift represents a depth measure to be shifted up or down to tie the two input petrophysical logs. Furthermore, the method 500 may display the two petrophysical logs before and after the depth matching and shifting procedure via a user interface.

At block 520, the method includes applying a post-alignment to the two petrophysical logs after the depth matching and shifting procedure. The method 500 may determine an updated correlation metric between the sequential values of the two petrophysical logs after the depth matching and shifting procedure. When the updated correlation metric exceeds a second predetermined threshold, the method 500 may use the alignment shift to all logs in the second logging job. When the updated correlation metric does not exceed the second predetermined threshold, the method 500 may proceed to block 505 to reprocess the two petrophysical logs.

Particular embodiments may repeat one or more steps of the method of FIG. 5A, where appropriate. Although this disclosure describes and illustrates particular steps of the method of FIG. 5A as occurring in a particular order, this disclosure contemplates any suitable steps of the method of FIG. 5A occurring in any suitable order. Moreover, although this disclosure describes and illustrates an example method to characterize a reservoir by automatic depth alignment of petrophysical logs using an automatic log alignment workflow, including the particular steps of the method of FIG. 5A, this disclosure contemplates any suitable method including any suitable steps, which may include all, some, or none of the steps of the method of FIG. 5A, where appropriate. Furthermore, although this disclosure describes and illustrates particular components, devices, or systems carrying out particular steps of the method of FIG. 5A, this disclosure contemplates any suitable combination of any suitable components, devices, or systems carrying out any suitable steps of the method of FIG. 5A.

FIG. 5B illustrates a flow chart that shows a method 530 for data preprocessing and standardization in accordance with one or more embodiments. The method 530 may implement a data preprocessing and standardization step to prepare two correlation logs for a depth matching and shift procedure. At block 532, the method 530 includes extracting a first sampling rate and a first log length from a first correlation log. By way of example, a first correlation log may include a first gamma ray curve with a first log length of 80 ft and a first sampling rate of 2 samples per ft.

At block 534, the method 530 includes extracting a second sampling rate and a second log length from a second correlation log. For example, a second correlation log may include a second gamma ray curve with a second log length of 100 ft and a second sampling rate of 40 samples per foot.

At block 536, the method 530 includes comparing the first sampling rate to the second sampling rate to determine, at block 538,
whether the first sampling rate is equal to the second sampling rate. As shown in FIG. 5B, if the first sampling rate is equal to the second sampling rate, the process may proceed to block 542. If the first sampling rate is not equal to the second sampling rate, the process may proceed to block 540.

At block 540, the method 530 includes sampling up the two correlation logs in the logging job with the highest sampling rate. For example, the method 500 may use an interpolation algorithm to resample the first correlation log from the first sampling rate of 2 samples per foot to the second sampling rate of one sample per foot.

At block 542, the method 530 includes comparing the first log length to the second log length to determine whether the first log length is equal to the second log length. As shown in FIG. 5B, if the first log length is equal to the second log length, the process may proceed to block 546. If the first log length is not equal to the second log length, the process may proceed to block 544.

At block 544, the method 530 includes padding the shortest log length with zeros. Using the foregoing example, the method 530 may modify the first correction log to a length of 100 ft by tailing zeros to the end of the first correction log.

At block 546, the method 530 includes applying FFTs to the first correlation log and the second correction log to convert the first correction log and the second correction log from a spatial domain to a frequency domain.

Particular embodiments may repeat one or more steps of the method of FIG. 5B, where appropriate. Although this disclosure describes and illustrates particular steps of the method of FIG. 5B as occurring in a particular order, this disclosure contemplates any suitable steps of the method of FIG. 5B occurring in any suitable order. Moreover, although this disclosure describes and illustrates an example method to pre-process two input petrophysical logs, including the particular steps of the method of FIG. 5B, this disclosure contemplates any suitable method including any suitable steps, which may include all, some, or none of the steps of the method of FIG. 5B, where appropriate. Furthermore, although this disclosure describes and illustrates particular components, devices, or systems carrying out particular steps of the method of FIG. 5B, this disclosure contemplates any suitable combination of any suitable components, devices, or systems carrying out any suitable steps of the method of FIG. 5B.

FIG. 5C illustrates a flow chart that shows a method 550 for applying an alignment procedure to two petrophysical logs in accordance with one or more embodiments. In some embodiments, the method 550 may apply the alignment procedure to tie two input petrophysical logs to the same reference depth. At block 552, the method 550 includes receiving a first correlation log and a second correlation log in a depth-domain. For example, the first correlation log may include a first gamma ray log from a first LWD job of a parent wellbore, and the second correlation log may include a second gamma ray log of a second LWD from a lateral wellbore extending from the parent wellbore.

At block 554, the method 550 includes transforming, using an FFT algorithm, the first correlation log in the depth-domain into a first frequency-domain log. In particular, the first frequency-domain log may include a plurality of spectral attributes, such as magnitude, phase, and frequency.

At block 556, the method 550 includes transforming, using the FFT algorithm, the second correlation log in the depth-domain into a second frequency-domain log. In particular, the second frequency-domain log may include a plurality of spectral attributes, such as magnitude, phase, and frequency.

At block 558, the method 550 includes determining, using the first frequency-domain log and the second frequency-domain log, a correlation curve of the first correlation log and the second correlation log. In some embodiments, the method 550 may determine the correlation curve of the first and second correlation logs by generating an inverse of a product of multiplying the first frequency-domain log with a conjugate of the second frequency-domain log.

At block 560, the method 550 includes determining, using the correlation curve, an alignment shift between the first correlation log and the second correlation log using an index of a maximum value that maximizes the correlation between the two logs. In some embodiments, the method 500 extracts the index of the maximum value in the correlation curve of the first correlation log and the second correlation log. The method 500 determines the alignment shift between the first correlation log and the second correlation log by using the index of a maximum value to convert the number of samples to depth units based on a corresponding sampling rate of the second correlation log.

At block 562, the method 550 includes determining, using the alignment shift, a depth-corrected second correlation log by applying the alignment shift to the second correlation log. Furthermore, the correlation metric is calculated before and after applying the alignment shift to the second correlation log to evaluate the performance of the alignment procedure in an automated process. For example, the correlation coefficient has a value of 0.5 before applying the alignment shift to the second correlation log. After applying the alignment shift to the second correlation log, the correlation coefficient has a value of 0.95. The comparison of the correlation coefficients indicates the improved performance of the alignment procedure. When the correlation coefficient is not improved after the alignment procedure, the method 500 may automatically proceed to block 505 to reprocess the two input correlation logs to evaluate the data quality of the two input petrophysical logs to ensure that the two correlation logs are correctly profiled against measured depth to a proper data frame for analysis.

At block 564, the method 550 includes outputting the depth-corrected second correlation log to a subsequent process of reservoir characterization.

Particular embodiments may repeat one or more steps of the method of FIG. 5C, where appropriate. Although this disclosure describes and illustrates particular steps of the method of FIG. 5C as occurring in a particular order, this disclosure contemplates any suitable steps of the method of FIG. 5C occurring in any suitable order. Moreover, although this disclosure describes and illustrates an example method to apply an alignment procedure to two petrophysical logs, including the particular steps of the method of FIG. 5C, this disclosure contemplates any suitable method including any suitable steps, which may include all, some, or none of the steps of the method of FIG. 5C, where appropriate. Furthermore, although this disclosure describes and illustrates particular components, devices, or systems carrying out particular steps of the method of FIG. 5C, this disclosure contemplates any suitable combination of any suitable components, devices, or systems carrying out any suitable steps of the method of FIG. 5C.

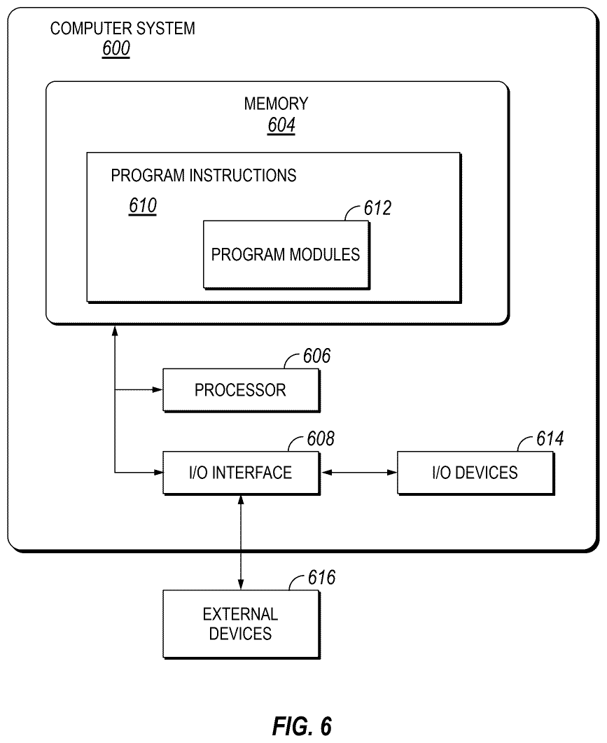

FIG. 6 is a functional block diagram of a computer system (or “system”) 600 in accordance with one or more embodiments. In some embodiments, system 600 is a programmable logic controller (PLC). System 600 may include memory 604, processor 606, and input/output (I/O) interface 608. Memory 604 may include non-volatile memory (for example, flash memory, read-only memory (ROM), programmable read-only memory (PROM), erasable programmable read-only memory (EPROM), electrically erasable programmable read-only memory (EEPROM)), volatile memory (for example, random access memory (RAM), static random access memory (SRAM), synchronous dynamic RAM (SDRAM)), or bulk storage memory (for example, CD-ROM or DVD-ROM, hard drives). Memory 604 may include a non-transitory computer-readable storage medium (for example, a non-transitory program storage device) having program instructions 610 stored thereon. Program instructions 610 may include program modules 612 that are executable by a computer processor (for example, processor 606) to cause the functional operations described, such as those described with regard to control system 114, method 500, method 530, or method 550.

Processor 606 may be any suitable processor capable of executing program instructions. Processor 606 may include a central processing unit (CPU) that carries out program instructions (for example, the program instructions of the program modules 612) to perform the arithmetical, logical, or input/output operations described. Processor 606 may include one or more processors. I/O interface 608 may provide an interface for communication with one or more I/O devices 614, such as a joystick, a computer mouse, a keyboard, or a display screen (for example, an electronic display for displaying a graphical user interface (GUI)). I/O devices 614 may include one or more of the user input devices. I/O devices 614 may be connected to I/O interface 608 by way of a wired connection (for example, an Industrial Ethernet connection) or a wireless connection (for example, a Wi-Fi connection). I/O interface 608 may provide an interface for communication with one or more external devices 616. In some embodiments, I/O interface 608 includes one or both of an antenna and a transceiver. In some embodiments, external devices 616 include logging tools, lab test systems, well pressure sensors, well flowrate sensors, or other sensors described in connection with control system 114.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described herein are to be taken as examples of embodiments. Elements and materials may be substituted for those illustrated and described herein, parts and processes may be reversed or omitted, and certain features of the embodiments may be utilized independently, all as would be apparent to one skilled in the art after having the benefit of this description of the embodiments. Changes may be made in the elements described herein without departing from the spirit and scope of the embodiments as described in the following claims. Headings used herein are for organizational purposes only and are not meant to be used to limit the scope of the description.

It will be appreciated that the processes and methods described herein are example embodiments of processes and methods that may be employed in accordance with the techniques described herein. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination of software and hardware. Some or all of the portions of the processes and methods may be implemented by one or more of the processors/modules/applications described here.

As used throughout this application, the word “may” is used in a permissive sense (that is, meaning having the potential to), rather than the mandatory sense (that is, meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (for example, by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic, or magnetic quantities within memories, registers, or other information storage devices, transmission devices, or display devices of the special purpose computer or similar special purpose electronic processing/computing device.

At least one embodiment is disclosed and variations, combinations, modifications of the embodiment(s), or features of the embodiment(s) made by a person having ordinary skill in the art are within the scope of the disclosure. Alternative embodiments that result from combining, integrating, or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (for example, from about 1 to about 10 includes, 2, 3, 4, etc.; greater than 0.10 includes 0.11, 0.12, 0.13, etc.). The use of the term “about” (or its variants) means ±10% of the subsequent number, unless otherwise stated.

Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description but is defined by the claims that follow, that scope including all equivalents of the subject matter of the claims. Each and every claim is incorporated as further disclosure into the specification and the claims are embodiment(s) of the present disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise.

Many other embodiments will be apparent to those of skill in the art upon reviewing the description. The scope of the subject matter of the present disclosure therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method of characterizing a reservoir by automatic depth alignment of petrophysical logs, comprising:
receiving a first correlation log and a second correlation log in a depth-domain;
transforming, using a Fast Fourier Transform (FFT), the first correlation log in the depth-domain into a first frequency-domain log;
transforming, using the FFT, the second correlation log in the depth-domain into a second frequency-domain log;
determining, using the first frequency-domain log and the second frequency-domain log, a correlation curve of the first correlation log and the second correlation log;
determining, using the correlation curve, a correlation metric of the first correlation log and the second correlation log;
comparing the correlation metric to a first predetermined threshold;
in response to determining the correlation metric is below the first predetermined threshold,
determining, using the correlation curve, an alignment shift between the first correlation log and the second correlation log;
and a depth-corrected second correlation log by applying the alignment shift to the second correlation log;
updating the correlation metric using the first correlation log and the depth-corrected second correlation log;
comparing the correlation metric to a second predetermined threshold; and
in response to determining the correlation metric is above the second predetermined threshold, outputting the depth-corrected second correlation log to a subsequent process of reservoir characterization.

2. The method of claim 1, further comprising:
extracting a first sampling rate from the first correlation log;
extracting a second sampling rate from the second correlation log; and
determining, using the first sampling rate and the second sampling rate, a maximum sampling rate for the first correlation log and the second correlation log.

3. The method of claim 2, further comprising:
determining a first interpolated correlation log by applying interpolation to the first correlation log from the first sampling rate to the maximum sampling rate when the first sampling rate is less than the maximum sampling rate; and
transforming, using the FFT, the first interpolated correlation log in the depth-domain into the first frequency-domain log.

4. The method of claim 2, further comprising:
determining a second interpolated correlation log by applying interpolation to the second correlation log from the second sampling rate to the maximum sampling rate when the second sampling rate is less than the maximum sampling rate; and
transforming, using the FFT, the second interpolated correlation log in the depth-domain into the second frequency-domain log.

5. The method of claim 1, wherein determining the correlation curve of the first correlation log and the second correlation log comprises generating an inverse of a product of multiplying the first frequency-domain log with a conjugate of the second frequency-domain log.

6. The method of claim 1, wherein the correlation metric comprises a maximum value that maximizes the correlation between the first correlation log and the second correlation log.

7. The method of claim 6, further comprising:
determining the alignment shift between the first correlation log and the second correlation log by converting an index of the maximum value to the depth-domain.

8. The method of claim 1, wherein:
the first correlation log is a petrophysical log comprising a gamma ray log or a neutron log; and
the second correlation log is a petrophysical log comprising a gamma ray log or a neutron log.

9. The method of claim 1, wherein:
transforming a first length of the first correlation log and a second length of the second correlation log to a predetermined length by tailing zeros to the end of the corresponding correlation log.

10. The method of claim 1, wherein the first correlation log is a reference log.

11. A system of characterizing a reservoir by automatic depth alignment of petrophysical logs, comprising:
a processor; and
a computer-readable non-transitory storage medium comprising instructions that, when executed by the processor, cause the processor to perform operations comprising:
receiving a first correlation log and a second correlation log in a depth-domain;
transforming, using a Fast Fourier Transform (FFT), the first correlation log in the depth-domain into a first frequency-domain log;
transforming, using the FFT, the second correlation log in the depth-domain into a second frequency-domain log;
determining, using the first frequency-domain log and the second frequency-domain log, a correlation curve of the first correlation log and the second correlation log;
determining, using the correlation curve, a correlation metric of the first correlation log and the second correlation log;
comparing the correlation metric to a first predetermined threshold;
in response to determining the correlation metric is below the first predetermined threshold,
determining, using the correlation curve, an alignment shift between the first correlation log and the second correlation log and a depth-corrected second correlation log by applying the alignment depth shift to the second correlation log;
updating the correlation metric using the first correlation log and the depth-corrected second correlation log;
comparing the correlation metric to a second predetermined threshold; and
in response to determining the correlation metric is above the second predetermined threshold, outputting the depth-corrected second correlation log to a subsequent process of reservoir characterization.

12. The system of claim 11, the operations further comprising:
extracting a first sampling rate from the first correlation log;
extracting a second sampling rate from the second correlation log; and
determining, using the first sampling rate and the second sampling rate, a maximum sampling rate for the first correlation log and the second correlation log.

13. The system of claim 12, the operations further comprising:
determining a first interpolated correlation log by applying interpolation to the first correlation log from the first sampling rate to the maximum sampling rate when the first sampling rate is less than the maximum sampling rate; and
transforming, using the FFT, the first interpolated correlation log in the depth-domain into the first frequency-domain log.

14. The system of claim 12, the operations further comprising:
determining a second interpolated correlation log by applying interpolation to the second correlation log from the second sampling rate to the maximum sampling rate when the second sampling rate is less than the maximum sampling rate; and
transforming, using the FFT, the second interpolated correlation log in the depth-domain into the second frequency-domain log.

15. The system of claim 1, wherein determining the correlation curve of the first correlation log and the second correlation log comprises generating an inverse of a product of multiplying the first frequency-domain log with a conjugate of the second frequency-domain log.

16. The system of claim 1, wherein the correlation metric comprises a maximum value that maximizes the correlation between the first correlation log and the second correlation log.

17. The system of claim 16, the operations further comprising:
determining the alignment shift between the first correlation log and the second correlation log by converting an index of the maximum value to the depth-domain.

18. The system of claim 11, wherein:
the first correlation log is a petrophysical log comprising a gamma ray log or a neutron log, and
the second correlation log is a petrophysical log comprising a gamma ray log or a neutron log.

19. The system of claim 11, wherein:
transforming a first length of the first correlation log and a second length of the second correlation log to a predetermined length by tailing zeros to the end of the corresponding correlation log.

20. A non-transitory computer-readable medium comprising instructions that are configured, when executed by a processor, to perform operations comprising:
receiving a first correlation log and a second correlation log in a depth-domain;
transforming, using a Fast Fourier Transform (FFT), the first correlation log in the depth-domain into a first frequency-domain log;
transforming, using the FFT, the second correlation log in the depth-domain into a second frequency-domain log;
determining, using the first frequency-domain log and the second frequency-domain log, a correlation curve of the first correlation log and the second correlation log;
determining, using the correlation curve, a correlation metric of the first correlation log and the second correlation log;
comparing the correlation metric to a first predetermined threshold;
in response to determining the correlation metric is below the first predetermined threshold,
determining, using the correlation curve, an alignment shift between the first correlation log and the second correlation log and a depth-corrected second correlation log by applying the alignment depth shift to the second correlation log;
updating the correlation metric using the first correlation log and the depth-corrected second correlation log;
comparing the correlation metric to a second predetermined threshold; and
in response to determining the correlation metric is above the second predetermined threshold, outputting the depth-corrected second correlation log to a subsequent process of reservoir characterization.
